(19) United States
(12) Patent Application Publication
(10) Pub. No.: US 2009/0007021 A1
(43) Pub. Date: Jan. 1, 2009

(54) METHODS AND SYSTEMS FOR DYNAMIC GENERATION OF FILTERS USING A GRAPHICAL USER INTERFACE

(76) Inventor: Richard Hayton, Cambridge (GB)

Correspondence Address: CHOATE, HALL & STEWART / CITRIX SYSTEMS, INC., TWO INTERNATIONAL PLACE, BOSTON, MA, 02110, US

(21) Appl. No.: 11/769,893

(22) Filed: Jun. 28, 2007

(51) Int. Cl. G06F 3/048

(52) U.S. Cl. 715/843

(57) ABSTRACT

A method for dynamic generation of filters using a graphical user interface includes the step of describing a first clause of a filter in a first graphical user interface element. At least one of: i) a conjunctive clause of the filter in a second graphical user interface element, and ii) a disjunctive sub-clause of the first clause of the filter in the first graphical user interface element, are described. A filter is generated, responsive to the contents of the first graphical user interface element and the second graphical user interface element.

### FIELD OF THE INVENTION

The present invention relates to methods and systems for generating filters. In particular, the present invention relates to methods and systems for dynamic generation of complex filters using a graphical user interface.

### BACKGROUND OF THE INVENTION

Administrators granting users access to resources may need to manage complex filters defining user access rights. An administrator may use a filter editor to generate Boolean expressions defining a filter. Typically, many administrative tools avoid giving the administrator complete freedom in defining filters, as there is a danger of confusing the administrator or, worse, creating filters that are difficult for the administrator to understand and manage. Typical administrative tools force the administrator to create filters of a fixed structure, for example, a list of conditions all of which must apply (implicit AND) or a list of conditions at least one of which must apply (implicit OR). However, limiting an administrator's ability to define filters may make it harder for the administrator to specify complex but valid conditions. For example, in the Windows file system, it is possible to indicate that a user may read a file if they are a member of either group A or group B. It is not typically possible to specify that a user may read the file only if they are a member of both groups A and B, or only if the user belongs to group A but not group B.

### BRIEF SUMMARY OF THE INVENTION

In one aspect, a method for dynamic generation of filters using a graphical user interface includes the step of describing a first clause of a filter in a first graphical user interface element. At least one of: i) a conjunctive clause of the filter in a second graphical user interface element, and ii) a disjunctive sub-clause of the first clause of the filter in the first graphical user interface element, are described. A filter is generated, responsive to the contents of the first graphical user interface element and the second graphical user interface element.

In one embodiment, the first clause comprises a second filter. In another embodiment, the description of the first clause is received from a user via a third graphical user interface element. In still another embodiment, the first clause of the filter is described using a non-algebraic language.

In one embodiment, at least one of: i) a disjunctive clause of the filter in a second graphical user interface element, and ii) a conjunctive sub-clause of the first clause of the filter in the first graphical user interface element are described. In another embodiment, a conjunctive clause of the filter is described using a non-algebraic language. In still another embodiment, a disjunctive sub-clause of the first clause of the filter is described using a non-algebraic language. In even still another embodiment, conjunctive or disjunctive sub-clauses of conjunctive or disjunctive sub-clauses are described. In yet another embodiment, a plurality of clauses of the filter is described.

In another aspect, a system for dynamic generation of filters using a graphical user interface includes a graphical user interface element and a filter. The graphical user interface element comprises a description of a first clause of a filter. The system includes one of a second graphical user interface element comprising a description of at least one conjunctive clause of the filter, and ii) a description in the first graphical user interface element of a disjunctive sub-clause of the first clause of the filter. The filter is generated responsive to the contents of the first graphical user interface element and the second graphical user interface element.

### BRIEF DESCRIPTION OF THE DRAWINGS

The foregoing and other objects, aspects, features, and advantages of the invention will become more apparent and better understood by referring to the following description taken in conjunction with the accompanying drawings, in which:

FIG. 1A is a block diagram depicting an embodiment of a network environment comprising client machines in communication with remote machines;

FIGS. 1B and 1C are block diagrams depicting embodiments of computers useful in connection with the methods and systems described herein;

FIG. 2A is a block diagram depicting one embodiment of a network including a policy engine;

FIG. 2B is a block diagram depicting one embodiment of a policy engine, including a first component comprising a condition database and a logon agent, and including a second component comprising a policy database;

FIG. 3A is a block diagram depicting one embodiment of a system for dynamic generation of filters using a graphical user interface;

FIG. 3B is a screen shot of one embodiment of a graphical user interface in a system for dynamic generation of filters using a graphical user interface;

FIG. 3C is a screen shot of an embodiment of a graphical user interface in a system for dynamic generation of filters using a graphical user interface;

FIG. 3D is a screen shot of an embodiment of a graphical user interface in a system for dynamic generation of filters using a graphical user interface;

FIG. 3E is a screen shot of an embodiment of a graphical user interface for adding a condition to a filter;

FIG. 3F is a screen shot depicting an embodiment of a graphical user interface for displaying a first filter included as a term in a second filter;

FIG. 3G is a screen shot of an embodiment of a graphical user interface for customizing a clause of a filter;

FIG. 4 is a flow diagram depicting one embodiment of the steps taken in a method for dynamic generation of filters using a graphical user interface;

FIG. 5A is a block diagram depicting one embodiment of a system for access routing and resource mapping using filters;

FIG. 5B is a screen shot depicting one embodiment of a subset of rules in a resource mapping policy; and

FIG. 6 is a flow diagram depicting one embodiment of the steps taken in a method for access routing and resource mapping using filters.

### DETAILED DESCRIPTION OF THE INVENTION

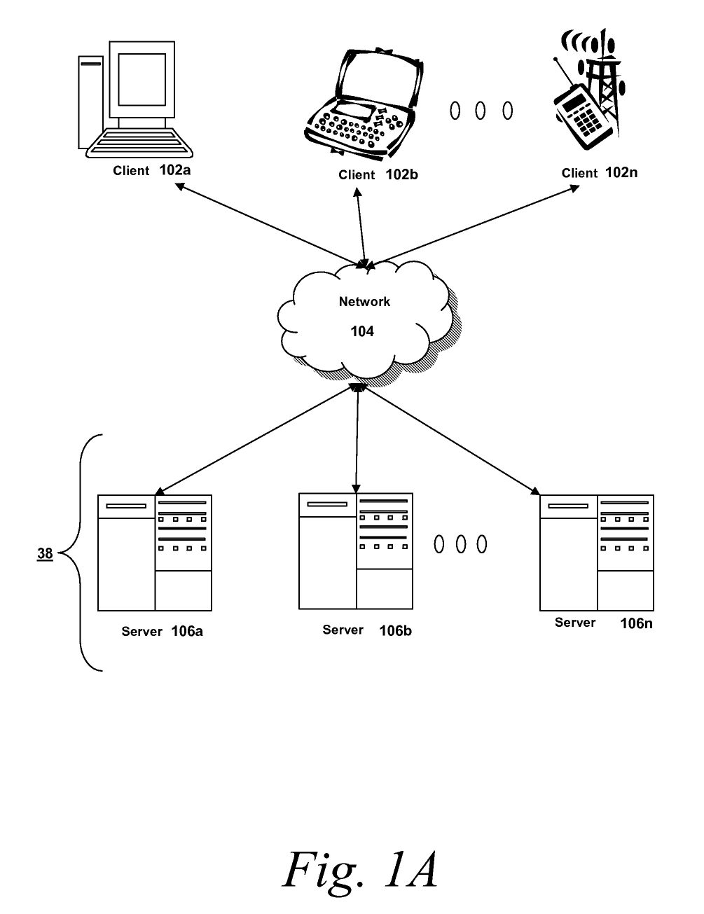

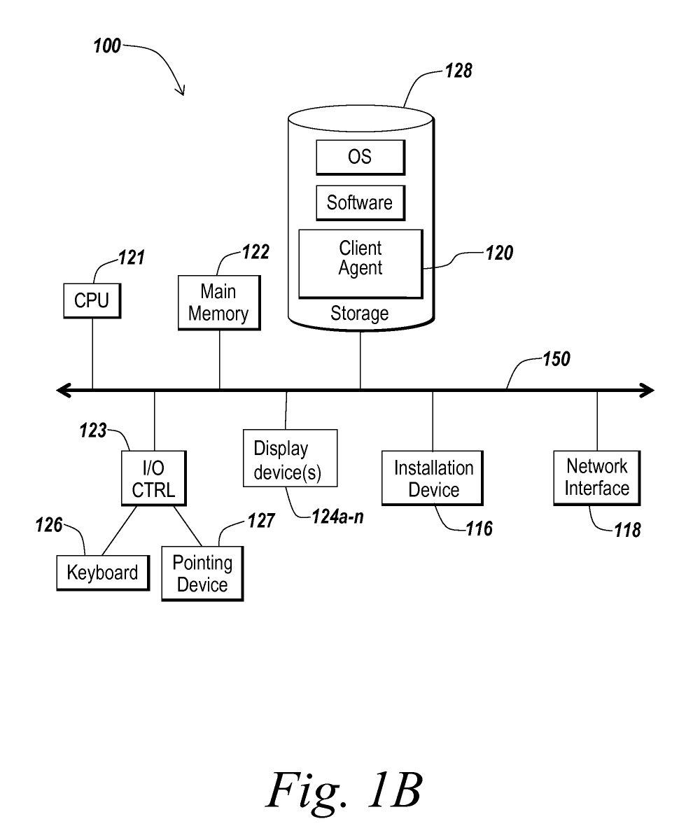

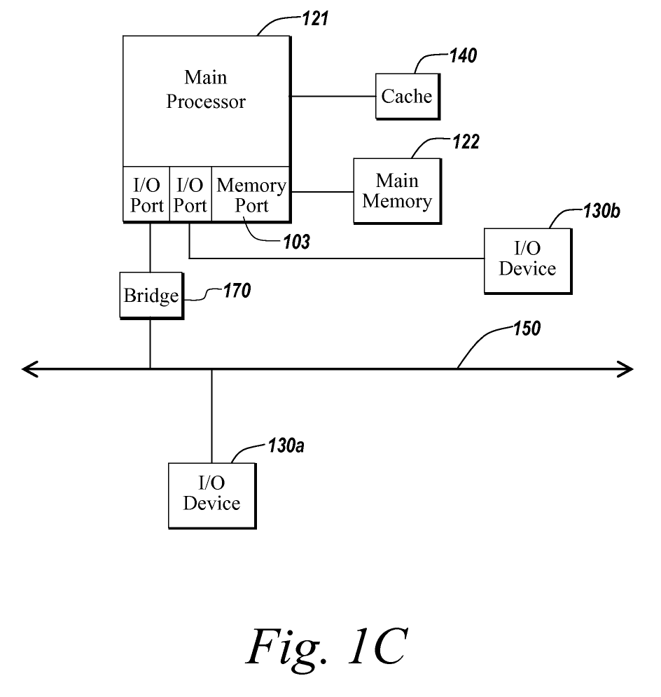

Referring now to FIG. 1A, an embodiment of a network environment is depicted. In brief overview, the network environment comprises one or more clients 102a-102n (also generally referred to as local machine(s) 102, or client(s) 102) in communication with one or more servers 106a-106n (also generally referred to as server(s) 106, or remote machine(s) 106) via one or more networks 104.

Although FIG. 1A shows a network 104 between the clients 102 and the servers 106, the clients 102 and the servers 106 may be on the same network 104. The network 104 can be a local-area network (LAN), such as a company Intranet, a metropolitan area network (MAN), or a wide area network (WAN), such as the Internet or the World Wide Web. In some embodiments, there are multiple networks 104 between the clients 102 and the servers 106. In one of these embodiments, a network 104′ may be a private network and a network 104 may be a public network. In another of these embodiments, a network 104 may be a private network and a network 104′ a public network. In still another embodiment, networks 104 and 104′ may both be private networks.

The network 104 may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. In some embodiments, the network 104 may comprise a wireless link, such as an infrared channel or satellite band. The topology of the network 104 may be a bus, star, or ring network topology. The network 104 and network topology may be of any such network or network topology as known to those ordinarily skilled in the art capable of supporting the operations described herein. The network may comprise mobile telephone networks utilizing any protocol or protocols used to communicate among mobile devices, including AMPS, TDMA, CDMA, GSM, GPRS or UMTS. In some embodiments, different types of data may be transmitted via different protocols. In other embodiments, the same types of data may be transmitted via different protocols.

In one embodiment, the system may include multiple, logically-grouped servers 106. In these embodiments, the logical group of servers may be referred to as a server farm 38. In some of these embodiments, the servers 106 may be geographically dispersed. In some cases, a farm 38 may be administered as a single entity. In other embodiments, the server farm 38 comprises a plurality of server farms 38. In one embodiment, the server farm executes one or more applications on behalf of one or more clients 102.

The servers 106 within each farm 38 can be heterogeneous. One or more of the servers 106 can operate according to one type of operating system platform (e.g., WINDOWS NT, manufactured by Microsoft Corp. of Redmond, Wash.), while one or more of the other servers 106 can operate on according to another type of operating system platform (e.g., Unix or Linux). The servers 106 of each farm 38 do not need to be physically proximate to another server 106 in the same farm 38. Thus, the group of servers 106 logically grouped as a farm 38 may be interconnected using a wide-area network (WAN) connection or a metropolitan-area network (MAN) connection. For example, a farm 38 may include servers 106 physically located in different continents or different regions of a continent, country, state, city, campus, or room. Data transmission speeds between servers 106 in the farm 38 can be increased if the servers 106 are connected using a local-area network (LAN) connection or some form of direct connection.

Server 106 may be a file server, application server, web server, proxy server, appliance, network appliance, gateway, application gateway, gateway server, virtualization server, deployment server, SSL VPN server, or firewall. In some embodiments, a server 106 provides a remote authentication dial-in user service, and is referred to as a RADIUS server. In other embodiments, a server 106 may have the capacity to function as either an application server or as a master application server. In one embodiment, a server 106 may include an Active Directory. The remote machine 30 may be an application acceleration appliance. For embodiments in which the remote machine 30 is an application acceleration appliance, the remote machine 30 may provide functionality including firewall functionality, application firewall functionality, or load balancing functionality. In some embodiments, the remote machine 30 comprises an appliance such as one of the line of appliances manufactured by the Citrix Application Networking Group, of San Jose, Calif., or Silver Peak Systems, Inc., of Mountain View, Calif., or of Riverbed Technology, Inc., of San Francisco, Calif., or of F5 Networks, Inc., of Seattle, Wash., or of Juniper Networks, Inc., of Sunnyvale, Calif.

The clients 102 may also be referred to as client nodes, client machines, endpoint nodes, or endpoints. In some embodiments, a client 102 has the capacity to function as both a client node seeking access to resources provided by a server and as a server providing access to hosted resources for other clients 102a-102n.

In some embodiments, a client 102 communicates with a server 106. In one embodiment, the client 102 communicates directly with one of the servers 106 in a farm 38. In another embodiment, the client 102 executes a program neighborhood application to communicate with a server 106 in a farm 38. In still another embodiment, the server 106 provides the functionality of a master node. In some embodiments, the client 102 communicates with the server 106 in the farm 38 through a network 104. Over the network 104, the client 102 can, for example, request execution of various applications hosted by the servers 106a-106n in the farm 38 and receive output of the results of the application execution for display. In some embodiments, only the master node provides the functionality required to identify and provide address information associated with a server 106b hosting a requested application.

In one embodiment, the server 106 provides the functionality of a web server. In another embodiment, the server 106a receives requests from the client 102, forwards the requests to a second server 106b and responds to the request by the client 102 with a response to the request from the server 106b. In still another embodiment, the server 106 acquires an enumeration of applications available to the client 102 and address information associated with a server 106 hosting an application identified by the enumeration of applications. In yet another embodiment, the server 106 presents the response to the request to the client 102 using a web interface. In one embodiment, the client 102 communicates directly with the server 106 to access the identified application. In another embodiment, the client 102 receives output data, such as display data, generated by an execution of the identified application on the server 106.

In some embodiments, the server 106 or a server farm 38 may be running one or more applications, such as an application providing a thin-client computing or remote display presentation application. In one embodiment, the server 106 or server farm 38 executes as an application any portion of the Citrix Access Suite™ by Citrix Systems, Inc., such as the MetaFrame or Citrix Presentation Server™, and/or any of the MICROSOFT WINDOWS Terminal Services manufactured by the Microsoft Corporation. In another embodiment, the application is an ICA client, developed by Citrix Systems, Inc. of Fort Lauderdale, Fla. In still another embodiment, the server 106 may run an application, which, for example, may be an application server providing email services such as MICROSOFT EXCHANGE manufactured by the Microsoft Corporation of Redmond, Wash., a web or Internet server, or a desktop sharing server, or a collaboration server. In yet another embodiment, any of the applications may comprise any type of hosted service or products, such as GOTOMEETING provided by Citrix Online Division, Inc. of Santa Barbara, Calif., WEBEX provided by WebEx, Inc. of Santa Clara, Calif., or Microsoft Office LIVE MEETING provided by Microsoft Corporation of Redmond, Wash.

A client 102 may execute, operate or otherwise provide an application, which can be any type and/or form of software, program, or executable instructions such as any type and/or form of web browser, web-based client, client-server application, a thin-client computing client, an ActiveX control, or a Java applet, or any other type and/or form of executable instructions capable of executing on client 102. In some embodiments, the application may be a server-based or a remote-based application executed on behalf of the client 102 on a server 106. In one embodiments the server 106 may display output to the client 102 using any thin-client or remote-display protocol, such as the Independent Computing Architecture (ICA) protocol manufactured by Citrix Systems, Inc. of Ft. Lauderdale, Fla. or the Remote Desktop Protocol (RDP) manufactured by the Microsoft Corporation of Redmond, Wash. The application can use any type of protocol and it can be, for example, an HTTP client, an FTP client, an Oscar client, or a Telnet client. In other embodiments, the application comprises any type of software related to voice over internet protocol (VoIP) communications, such as a soft IP telephone. In further embodiments, the application comprises any application related to real-time data communications, such as applications for streaming video and/or audio.

The client 102 and server 106 may be deployed as and/or executed on any type and form of computing device, such as a computer, network device or appliance capable of communicating on any type and form of network and performing the operations described herein. FIGS. 1B and 1C depict block diagrams of a computing device 100 useful for practicing an embodiment of the client 102 or a server 106. As shown in FIGS. 1B and 1C, each computing device 100 includes a central processing unit 121, and a main memory unit 122. As shown in FIG. 1B, a computing device 100 may include a visual display device 124, a keyboard 126 and/or a pointing device 127, such as a mouse. As shown in FIG. 1C, each computing device 100 may also include additional optional elements, such as one or more input/output devices 130a-130b (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit is provided by a microprocessor unit, such as: those manufactured by Intel Corporation of Mountain View, Calif.; those manufactured by Motorola Corporation of Schaumburg, Ill.; those manufactured by Transmeta Corporation of Santa Clara, Calif.; the RS/6000 processor, those manufactured by International Business Machines of White Plains, N.Y.; or those manufactured by Advanced Micro Devices of Sunnyvale, Calif. The computing device 100 may be based on any of these processors, or any other processor capable of operating as described herein.

Main memory unit 122 may be one or more memory chips capable of storing data and allowing any storage location to be directly accessed by the microprocessor 121, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC100 SDRAM, Double Data Rate SDRAM (DDR SDRAM), Enhanced SDRAM (ESDRAM), SyncLink DRAM (SLDRAM), Direct Rambus DRAM (DRDRAM), or Ferroelectric RAM (FRAM). The main memory 122 may be based on any of the above described memory chips, or any other available memory chips capable of operating as described herein. In the embodiment shown in FIG. 1B, the processor 121 communicates with main memory 122 via a system bus 150 (described in more detail below). FIG. 1C depicts an embodiment of a computing device 100 in which the processor communicates directly with main memory 122 via a memory port 103. For example, in FIG. 1C the main memory 122 may be DRDRAM.

FIG. 1C depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1C, the processor 121 communicates with various I/O devices 130 via a local system bus 150. Various buses may be used to connect the central processing unit 121 to any of the I/O devices 130, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 124, the processor 121 may use an Advanced Graphics Port (AGP) to communicate with the display 124. FIG. 1C depicts an embodiment of a computer 100 in which the main processor 121 communicates directly with I/O device 130b via HyperTransport, Rapid I/O, or InfiniBand. FIG. 1C also depicts an embodiment in which local busses and direct communication are mixed: the processor 121 communicates with I/O device 130a using a local interconnect bus while communicating with I/O device 130b directly.

The computing device 100 may support any suitable installation device 116, such as a floppy disk drive for receiving floppy disks such as 3.5-inch, 5.25-inch disks or ZIP disks, a CD-ROM drive, a CD-R/RW drive, a DVD-ROM drive, tape drives of various formats, USB device, hard-drive or any other device suitable for installing software and programs such as any client agent 120, or portion thereof. The computing device 100 may further comprise a storage device, such as one or more hard disk drives or redundant arrays of independent disks, for storing an operating system and other related software, and for storing application software programs such as any program related to the client agent 120. Optionally, any of the installation devices 116 could also be used as the storage device. Additionally, the operating system and the software can be run from a bootable medium, for example, a bootable CD, such as KNOPPIX®, a bootable CD for GNU/Linux that is available as a GNU/Linux distribution from knoppix.net.

Furthermore, the computing device 100 may include a network interface 118 to interface to a Local Area Network (LAN), Wide Area Network (WAN) or the Internet through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, CDMA, GSM, WiMax and direct asynchronous connections). In one embodiment, the computing device 100 communicates with other computing devices 100′ via any type and/or form of gateway or tunneling protocol such as Secure Socket Layer (SSL) or Transport Layer Security (TLS), or the Citrix Gateway Protocol manufactured by Citrix Systems, Inc. of Ft. Lauderdale, Fla. The network interface 118 may comprise a built-in network adapter, network interface card, PCMCIA network card, card bus network adapter, wireless network adapter, USB network adapter, modem or any other device suitable for interfacing the computing device 100 to any type of network capable of communication and performing the operations described herein.

A wide variety of I/O devices 130a-130n may be present in the computing device 100. Input devices include keyboards, mice, trackpads, trackballs, microphones, and drawing tablets. Output devices include video displays, speakers, inkjet printers, laser printers, and dye-sublimation printers. The I/O devices may be controlled by an I/O controller 123 as shown in FIG. 1B. The I/O controller may control one or more I/O devices such as a keyboard 126 and a pointing device 127, e.g., a mouse or optical pen. Furthermore, an I/O device may also provide storage and/or an installation medium 116 for the computing device 100. In still other embodiments, the computing device 100 may provide USB connections to receive handheld USB storage devices such as the USB Flash Drive line of devices manufactured by Twintech Industry, Inc. of Los Alamitos, Calif.

In some embodiments, the computing device 100 may comprise or be connected to multiple display devices 124a-124n, which each may be of the same or different type and/or form. As such, any of the I/O devices 130a-130n and/or the I/O controller 123 may comprise any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may comprise multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices, such as computing devices 100a and 100b connected to the computing device 100, for example, via a network. These embodiments may include any type of software designed and constructed to use another computer's display device as a second display device 124a for the computing device 100. One ordinarily skilled in the art will recognize and appreciate the various ways and embodiments that a computing device 100 may be configured to have multiple display devices 124a-124n.

In further embodiments, an I/O device 130 may be a bridge between the system bus 150 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

A computing device 100 of the sort depicted in FIGS. 1B and 1C typically operates under the control of operating systems, which control scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include: WINDOWS 3.x, WINDOWS 95, WINDOWS 98, WINDOWS 2000, WINDOWS NT 3.51, WINDOWS NT 4.0, WINDOWS CE, WINDOWS XP, and WINDOWS VISTA, all of which are manufactured by Microsoft Corporation of Redmond, Wash.; MacOS, manufactured by Apple Computer of Cupertino, California; OS/2, manufactured by International Business Machines of Armonk, N.Y.; and Linux, a freely-available operating system distributed by Caldera Corp. of Salt Lake City, Utah, or any type and/or form of a Unix operating system, among others.

The computer system 100 can be any workstation, desktop computer, laptop or notebook computer, server, handheld computer, mobile telephone or other portable telecommunication device, media playing device, a gaming system, mobile computing device, or any other type and/or form of computing, telecommunications or media device that is capable of communication and that has sufficient processor power and memory capacity to perform the operations described herein. For example, the computer system 100 may comprise a device of the IPOD family of devices manufactured by Apple Computer of Cupertino, California, a PLAYSTATION 2, PLAYSTATION 3, or PERSONAL PLAYSTATION PORTABLE (PSP) device manufactured by the Sony Corporation of Tokyo, Japan, a NINTENDO DS, NINTENDO GAMEBOY, NINTENDO GAMEBOY ADVANCED or NINTENDO REVOLUTION device manufactured by Nintendo Co., Ltd., of Kyoto, Japan, or an XBOX or XBOX 360™ device manufactured by the Microsoft Corporation of Redmond, Wash.

In some embodiments, the computing device 100 may have different processors, operating systems, and input devices consistent with the device. For example, in one embodiment, the computing device 100 is a Treo 180, 270, 600, 650, 680, 700p, 700w, or 750 smart phone manufactured by Palm, Inc. In some of these embodiments, the Treo smart phone is operated under the control of the PalmOS operating system and includes a stylus input device as well as a five-way navigator device.

In other embodiments the computing device 100 is a mobile device, such as a JAVA-enabled cellular telephone or personal digital assistant (PDA), such as the i55sr, i58sr, i85s, i88s, i90c, i95cl, or the im1100, all of which are manufactured by Motorola Corp. of Schaumburg, Ill., the 6035 or the 7135, manufactured by Kyocera of Kyoto, Japan, or the i300 or i330, manufactured by Samsung Electronics Co., Ltd., of Seoul, Korea.

In still other embodiments, the computing device 100 is a Blackberry handheld or smart phone, such as the devices manufactured by Research In Motion Limited, including the Blackberry 7100 series, 8700 series, 7700 series, 7200 series, the Blackberry 7520, or the Blackberry Pearl 8100. In yet other embodiments, the computing device 100 is a smart phone, Pocket PC, Pocket PC Phone, or other handheld mobile device supporting Microsoft Windows Mobile Software. Moreover, the computing device 100 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

In one embodiment, the server 106 includes a policy engine for controlling and managing the access to a resource, selection of an execution method for accessing the resource, and the delivery of resources. In another embodiment, the server 106 communicates with a policy engine. In some embodiments, the policy engine determines the one or more resources a user or client 102 may access. In other embodiments, the policy engine determines how the resource should be delivered to the user or client 102, e.g., the method of execution. In still other embodiments, the server 106 provides a plurality of delivery techniques from which to select a method of execution, such as a server-based computing, application streaming, or delivering the application locally to the client 102 for local execution.

In one embodiment, a client 102 requests execution of an application program and a server 106 selects a method of executing the application program. In another embodiment, the server 106 receives credentials from the client 102. In still another embodiment, the server 106 receives a request for an enumeration of available applications from the client 102. In yet another embodiment, in response to the request or receipt of credentials, the server 106 enumerates a plurality of application programs available to the client 102.

In some embodiments, the server 106 selects one of a predetermined number of methods for executing an enumerated application, for example, responsive to a policy of a policy engine. In one of these embodiments, an application delivery system on the server 106 makes the selection. In another of these embodiments, the server 106 may select a method of execution of the application enabling the client 102 to receive output data generated by execution of the application program on a server 106b. In still another of these embodiments, the server 106 may select a method of execution of the application enabling the client 102 to execute the application program locally after retrieving a plurality of application files comprising the application. In yet another of these embodiments, the server 106 may select a method of execution of the application to stream the application via the network 104 to the client 102. In this embodiment, a first plurality of files in a stream of files comprising the application may be stored and executed on the client 102 while the server 106 transmits a second plurality of files in the stream of files to the client. This process may be referred to as “application streaming.”

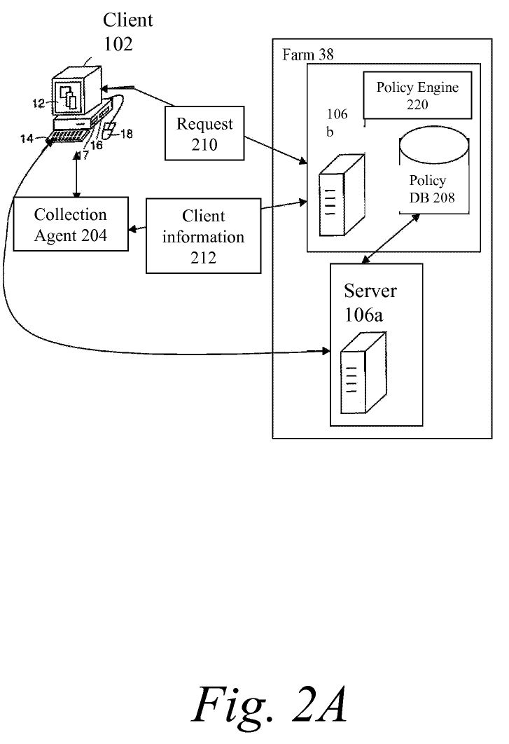

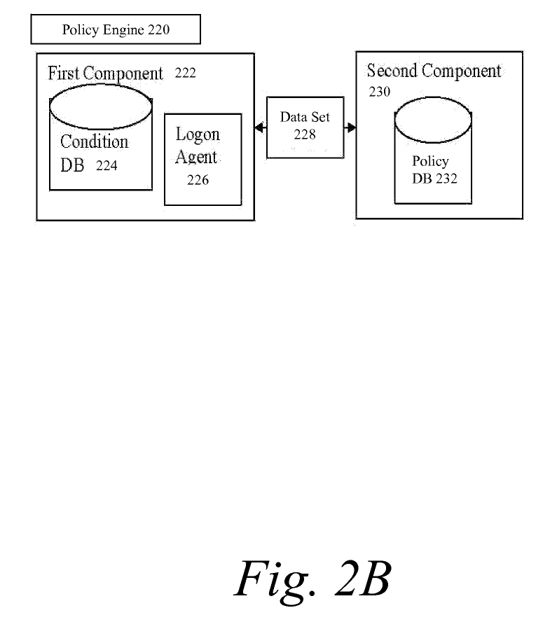

Referring now to FIG. 2A, a block diagram depicts one embodiment of a network including a policy engine 220. In one embodiment, the network includes a client 102, a collection agent 204, a policy engine 220, a policy database 208, a farm 38, and a server 106a. In another embodiment, the policy engine 220 is a server 106b. Although only one client 102, collection agent 304, policy engine 220, farm 38, and server 106a are depicted in the embodiment shown in FIG. 2A, it should be understood that the system may provide multiple ones of any or each of those components.

In brief overview, when the client 102 transmits a request 210 to the policy engine 220 for access to a resource, the collection agent 204 communicates with client 102, retrieving information about the client 102, and transmits the client information 212 to the policy engine 220. The policy engine 220 makes an access control decision by applying a policy from the policy database 208 to the received information 212.

In more detail, the client 102 transmits a request 210 for a resource to the policy engine 220. In one embodiment, the policy engine 220 resides on a server 106b. In another embodiment, the policy engine 220 is a server 106b. In still another embodiment, a server 106 receives the request 210 from the client 102 and transmits the request 210 to the policy engine 220. In a further embodiment, the client 102 transmits a request 210 for a resource to a server 106c, which transmits the request 210 to the policy engine 220.

Upon receiving the request, the policy engine 220 initiates information gathering by the collection agent 204. The collection agent 204 gathers information regarding the client 102 and transmits the information 212 to the policy engine 220.

In some embodiments, the collection agent 204 gathers and transmits the information 212 over a network connection. In some embodiments, the collection agent 204 comprises bytecode, such as an application written in the bytecode programming language JAVA. In some embodiments, the collection agent 204 comprises at least one script. In those embodiments, the collection agent 204 gathers information by running at least one script on the client 102. In some embodiments, the collection agent comprises an Active X control on the client 102. An Active X control is a specialized Component Object Model (COM) object that implements a set of interfaces that enable it to look and act like a control.

In one embodiment, the policy engine 220 transmits the collection agent 204 to the client 102. In another embodiment, a server 106 may store or cache the collection agent 204. The server 106 may then transmit the collection agent 204 to a client 102. In one embodiment, the policy engine 220 requires a second execution of the collection agent 204 after the collection agent 204 has transmitted information 212 to the policy engine 220. In this embodiment, the policy engine 220 may have insufficient information 212 to determine whether the client 102 satisfies a particular condition. In other embodiments, the policy engine 220 requires a plurality of executions of the collection agent 204 in response to received information 212.

In some embodiments, the policy engine 220 transmits instructions to the collection agent 204 determining the type of information the collection agent 204 gathers. In those embodiments, a system administrator may configure the instructions transmitted to the collection agent 204 from the policy engine 220. This provides greater control over the type of information collected. This also expands the types of access control decisions that the policy engine 220 can make, due to the greater control over the type of information collected. The collection agent 204 gathers information 212 including, without limitation, machine ID of the client 102, operating system type, existence of a patch to an operating system, MAC addresses of installed network cards, a digital watermark on the client device, membership in an Active Directory, existence of a virus scanner, existence of a personal firewall, an HTTP header, browser type, device type, network connection information such as internet protocol address or range of addresses, machine ID of the server 106, date or time of access request including adjustments for varying time zones, and authorization credentials. In some embodiments, a collection agent gathers information to determine whether access to a resource can be accelerated on the client using an acceleration program.

In some embodiments, the device type is a personal digital assistant. In other embodiments, the device type is a cellular telephone. In other embodiments, the device type is a laptop computer. In other embodiments, the device type is a desktop computer. In other embodiments, the device type is an Internet kiosk.

In some embodiments, the digital watermark includes data embedding. In some embodiments, the watermark comprises a pattern of data inserted into a file to provide source information about the file. In other embodiments, the watermark comprises data hashing files to provide tamper detection. In other embodiments, the watermark provides copyright information about the file.

In some embodiments, the network connection information pertains to bandwidth capabilities. In other embodiments, the network connection information pertains to Internet Protocol address. In still other embodiments, the network connection information consists of an Internet Protocol address. In one embodiment, the network connection information comprises a network zone identifying the logon agent to which the client 102 provided authentication credentials.

In some embodiments, the authorization credentials include a number of types of authentication information, including without limitation, user names, client names, client addresses, passwords, PINs, voice samples, one-time passcodes, biometric data, digital certificates, tickets, etc. and combinations thereof. After receiving the gathered information 212, the policy engine 220 makes an access control decision based on the received information 212.

Referring now to FIG. 2B, a block diagram depicts one embodiment of a policy engine 220, including a first component 222 comprising a condition database 224 and a logon agent 226, and including a second component 230 comprising a policy database 232. The first component 222 applies a condition from the condition database 224 to information received about client 102 and determines whether the received information satisfies the condition. In some embodiments, the condition database 224 stores filters, which are applied to information associated with a user or the user's client device.

In some embodiments, a condition or filter may require that the client 102 execute a particular operating system to satisfy the condition. In some embodiments, a condition or filter may require that the client 102 execute a particular operating system patch to satisfy the condition. In still other embodiments, a condition or filter may require that the client 102 provide a MAC address for each installed network card to satisfy the condition or filter. In some embodiments, a condition or filter may require that the client 102 indicate membership in a particular Active Directory to satisfy the condition. In another embodiment, a condition or filter may require that the client 102 execute a virus scanner to satisfy the condition. In other embodiments, a condition or filter may require that the client 102 execute a personal firewall to satisfy the condition. In some embodiments, a condition or filter may require that the client 102 comprise a particular device type to satisfy the condition or filter. In other embodiments, a condition or filter may require that the client 102 establish a particular type of network connection to satisfy the condition or filter.

In some embodiments, a logon agent 226 resides outside of the policy engine 220. In other embodiments, the logon agent 226 resides on the policy engine 220. In one embodiment, the first component 222 includes a logon agent 226, which initiates the information gathering about client 102. In some embodiments, the logon agent 226 further comprises a data store. In these embodiments, the data store includes the conditions for which the collection agent may gather information. In one of these embodiments, the data store is distinct from the condition database 224.

In some embodiments, the logon agent 226 initiates information gathering by executing the collection agent 204. In other embodiments, the logon agent 226 initiates information gathering by transmitting the collection agent 204 to the client 102 for execution on the client 102. In still other embodiments, the logon agent 226 initiates additional information gathering after receiving information 212. In one embodiment, the logon agent 226 also receives the information 212. In this embodiment, the logon agent 226 generates the data set 228 based upon the received information 212. In some embodiments, the logon agent 226 generates the data set 228 by applying a condition from the database 224 to the information received from the collection agent 204.

In another embodiment, the first component 222 includes a plurality of logon agents 226. In this embodiment, at least one of the plurality of logon agents 226 resides on each network domain from which a client 102 may transmit a resource request. In this embodiment, the client 102 transmits the resource request to a particular logon agent 226. In some embodiments, the logon agent 226 transmits to the policy engine 220 the network domain from which the client 102 accessed the logon agent 226. In one embodiment, the network domain from which the client 102 accesses a logon agent 226 is referred to as the network zone of the client 102.

In some embodiments, the condition database 224 stores the conditions or filters that the first component 222 applies to received information. The policy database 232 stores the policies that the second component 230 applies to the received data set 228. In some embodiments, the condition database 224 and the policy database 232 store data in an ODBC-compliant database. For example, the condition database 224 and the policy database 232 may be provided as an ORACLE database, manufactured by Oracle Corporation of Redwood Shores, Calif. In other embodiments, the condition database 224 and the policy database 232 can be a MICROSOFT ACCESS database or a MICROSOFT SQL server database, manufactured by Microsoft Corporation of Redmond, Wash.

In some embodiments, if the received information satisfies a condition, the first component 222 stores an identifier for that condition in a data set 228 and the second component applies a policy from the policy database to the data set. In other embodiments, after the first component 222 applies the received information to each condition in the condition database 224, the first component transmits the data set 228 to second component 230. In one embodiment, the first component 222 transmits only the data set 228 to the second component 230. Therefore, in this embodiment, the second component 230 does not receive information 212, only identifiers for satisfied conditions. The second component 230 receives the data set 228 and makes an access control decision by applying a policy from the policy database 232 based upon the conditions identified within data set 228.

In some embodiments, the policy engine determines whether the user and the client device satisfy the requirements expressed in a filter. In one of these embodiments, the policy engine accesses an enumeration of filters to make the determination. The enumeration of filters may be stored in a condition database. In another of these embodiments, the use of the filter replaces the need for the data set and the policy database. In still another of these embodiments, the policy engine includes a condition database co-located with a policy database. In yet another of these embodiments, where the condition database and the policy database are collocated, the policy engine does not generate a data set to determine whether the user and the client device satisfy the requirements expressed in the filter.

In one embodiment, policy database 232 stores the policies applied to the received information 212. In one embodiment, the policies stored in the policy database 232 are specified at least in part by the system administrator. In another embodiment, a user specifies at least some of the policies stored in the policy database 232. The user-specified policy or policies are stored as preferences. The policy database 232 can be stored in volatile or non-volatile memory or, for example, distributed through multiple servers.

In one embodiment, a policy allows access to a resource only if one or more conditions are satisfied. In another embodiment, a policy allows access to a resource but prohibits transmission of the resource to the client 102. Another policy might make connection contingent on the client 102 that requests access being within a secure network. In some embodiments, the resource is an application program and the client 102 has requested execution of the application program. In one of these embodiments, a policy may allow execution of the application program on the client 102. In another of these embodiments, a policy may enable the client 102 to receive a stream of files comprising the application program. In still another of these embodiments, a policy may allow only execution of the application program on a server 106, such as an application server, and require the server 106 to transmit output data to the client 102.

In some embodiments, a determination is made as to a type of connection to establish when granting access to a resource responsive to a determination by a policy engine such as the policy engine 220 described above in FIG. 2A and FIG. 2B. In other embodiments, a determination is made as to a method for granting access to a resource, such as a method for execution, responsive to a determination by a policy engine such as the policy engine 220 described above in connection with FIG. 2A and FIG. 2B. In still other embodiments, the server 106 receiving the credentials and the request to execute the resource further comprises such a policy engine 220. In yet other embodiments, the server 106 applies an access control policy to determine whether or not to grant access to the resource.

In some embodiments, filters are used in conjunction with policy engines as described above. In other embodiments, filters are used within policies, including, but not limited to, access control policies, auditing policies, network routing policies, load balancing policies, policies relating to error reporting, and failure handling policies. In still other embodiments, policy engines other than those described above use filters to evaluate an action to take with respect to a particular user or resource. In yet other embodiments, customized graphical user interfaces improve the ability of an administrator to generate filters.

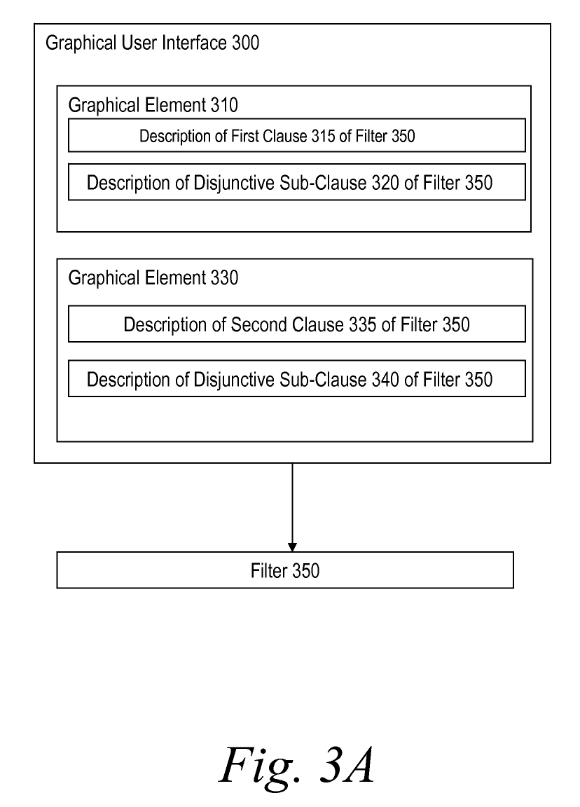

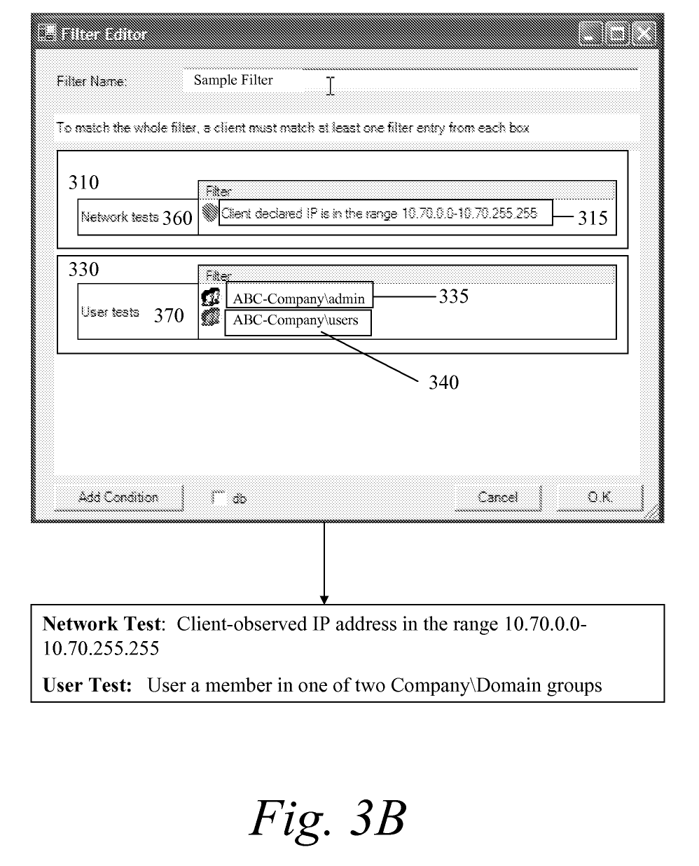

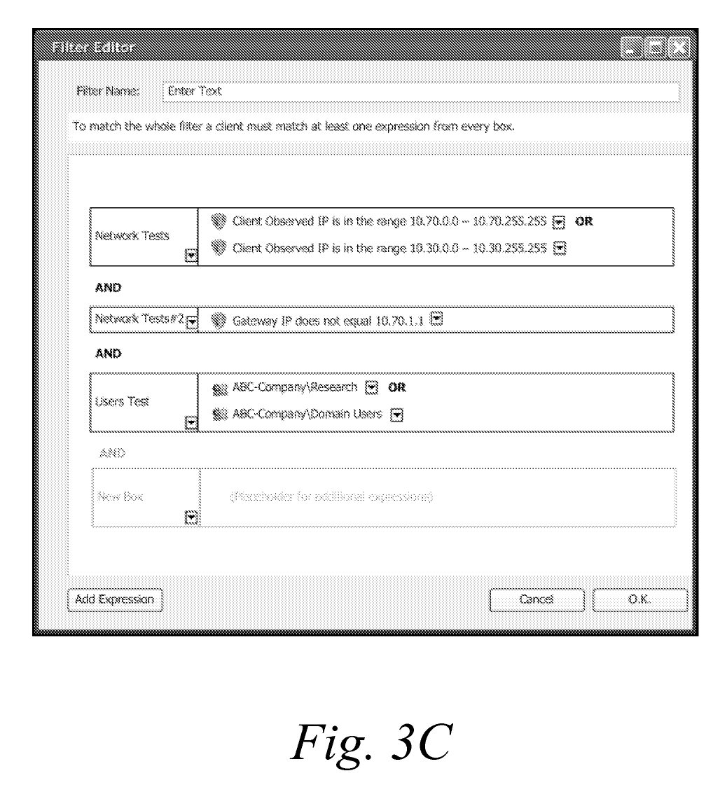

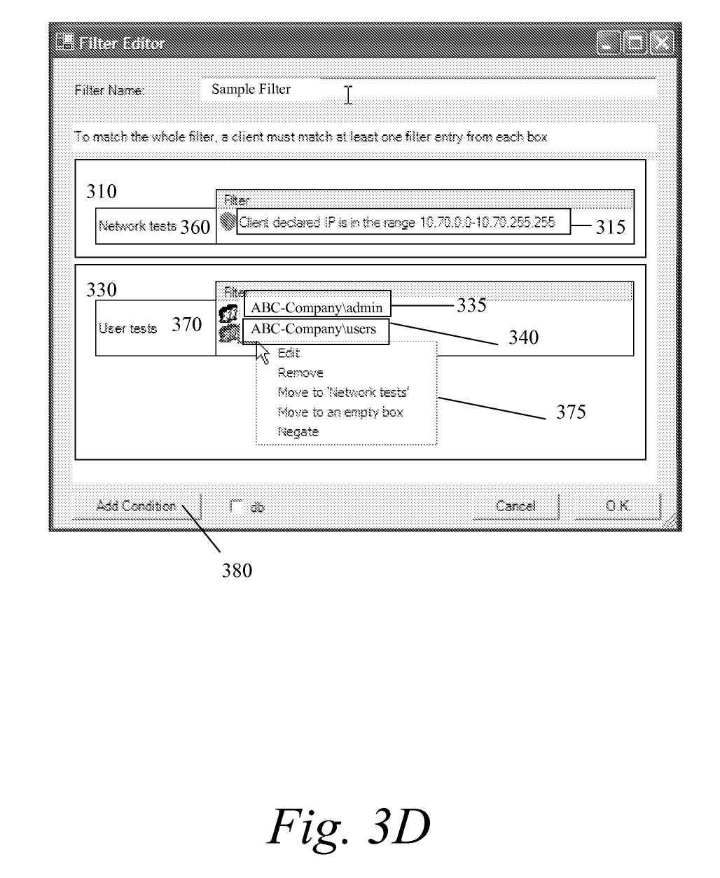

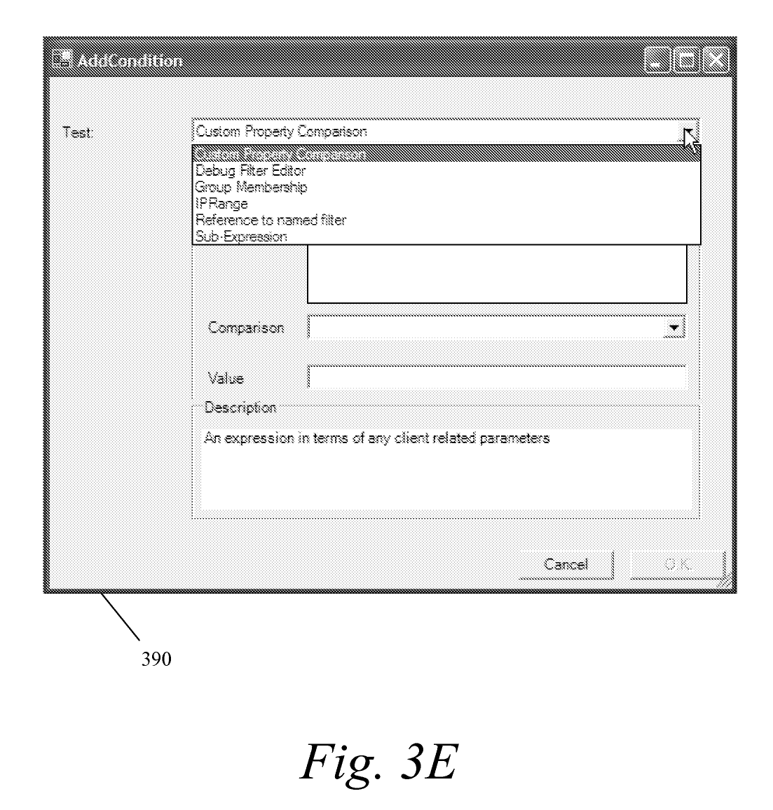

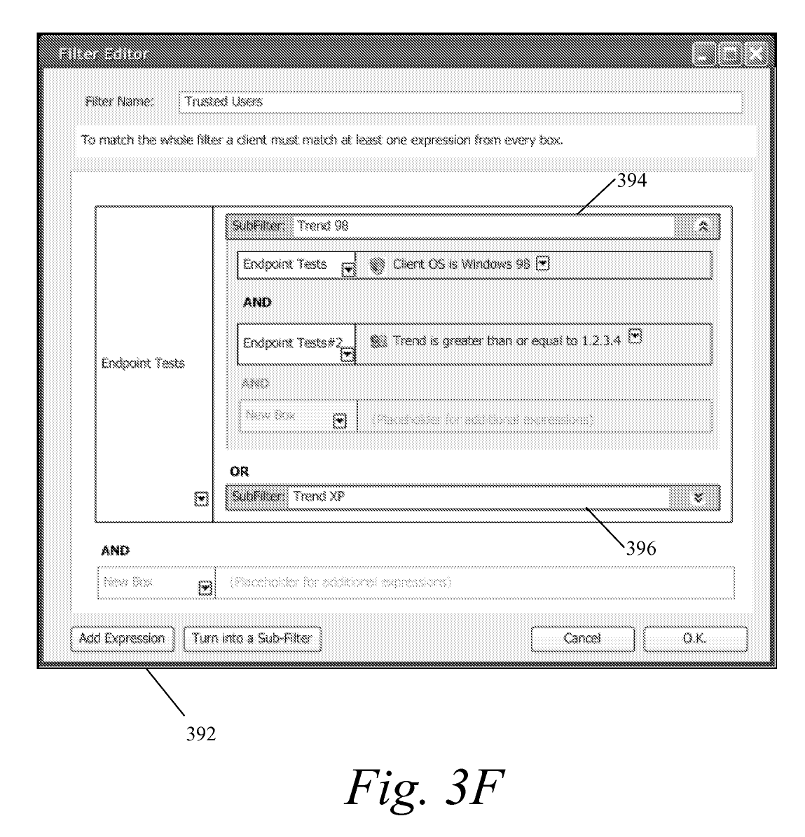

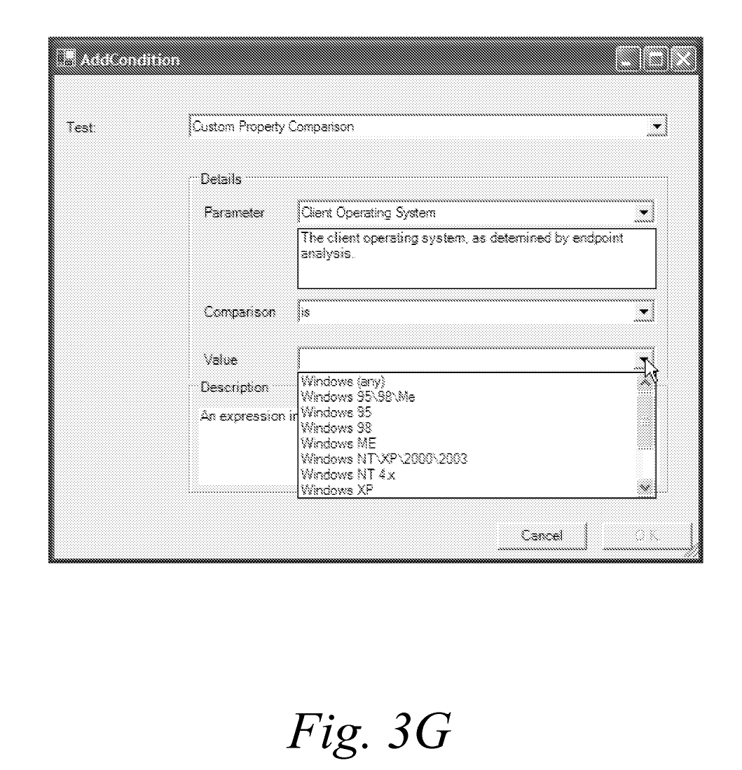

Referring now to FIG. 3A, a block diagram depicts one embodiments of a system for dynamic generation of filters using a graphical user interface. In brief overview, the system includes a graphical user interface 300, a graphical user interface element 310, and a filter 350. The graphical user interface element 310 includes a description of a first clause 315 of the filter 350. The system includes one of: i) a second graphical user interface element 330 comprising a description 335 of at least one conjunctive clause of the filter 350, and ii) a description 320 in the graphical user interface element 310 of a disjunctive sub-clause of the first clause of the filter 350. The filter 350 is generated responsive to the contents of the first graphical user interface element 310 and the second graphical user interface element 330. Although only one graphical user interface 300, a graphical user interface element 310, and a filter 350 are depicted in the embodiment shown in FIG. 3A, it should be understood that the system may provide multiple ones of any or each of those components.

In one embodiment, an access control list maps at least one filter to an allowed or denied permission setting included in the access control list. In another embodiment, a filter is a simple or compound condition that may or may not be met by a client requesting access to a resource. In still another embodiment, simple conditions include group membership, role membership, IP range membership, and a characteristic of a client device requesting access to a resource, such as whether the client device executes a particular application or has access to a particular hardware resource. In yet another embodiment, compound conditions are combinations of simple conditions that may be defined using a filter editor.

In some embodiments, a filter is used to describe at least one characteristic for evaluation. In one of these embodiments, the at least one characteristic is associated with a resource. In another of these embodiments, the at least one characteristic is associated with a user. In still another of these embodiments, the at least one characteristic is associated with a combination of users or resources. In yet another of these embodiments, the at least one characteristic is evaluated to make a policy decision, such as an access control decision. In other embodiments, filters are used to determine whether at least one entity matches at least one specified condition.

In one embodiment, a filter describes at least one characteristic of a resource. In another embodiment, a filter may specify a group of resources to which a particular resource should belong to satisfy the filter, such as, for example, specifying a particular named group of resources (such as, “office applications”), and specifying an operating system from which the resource is accessed (the WINDOWS VISTA operating system), and specifying a display capability supported by a system from which the resource is accessed. In still another embodiment, and for example, a filter may include a “leaf” condition specifying at least one of the following: a group of resources to which the resource should belong, a sub-directory which should enumerate the resource, an operating system capable of supporting the resource, a computing capability provided by a system from which the resource is accessed (such as a display capability or computing functionality), a required network characteristic (such as a per-application IP address), an environment in which the resource should execute (for example, an isolation environment), or a licensing requirement (for example, requiring a license for a specific user or for a specific type of request).

In one embodiment, a filter describes a characteristic associated with a combination of a user and a resource. In another embodiment, the filter may specify a first condition associated with a user and a second condition associated with a resource, and to satisfy the filter, the user and the filter must each satisfy the specified conditions. In still another embodiment, the filter specifies that a user be authorized to access a resource—for example, that the use own the resource, be licensed to use the resource, or have permission from an external policy system to access the resource. In yet another embodiment, for example, a filter specifies that a user satisfy a first filter and that the resource satisfy a second filter.

In one embodiment, a filter applies to a plurality of users. In another embodiment, a filter may specify a condition that a group of users involved in a collaborative application must all satisfy in order to satisfy the filter, for example, that all users belong to a particular group, or that at least one of the plurality of users has a particular role. In still another embodiment, a filter applies to a plurality of resources. In still even another embodiment, a filter applies to a plurality of users and to a resource. In yet another embodiment, a filter applies to a plurality of resources and to a user.

In some embodiments, a filter defines a dynamic group. In one of these embodiments, the filter identifies a user belonging to the dynamic group. In another of these embodiments, the filter identifies a user excluded from the dynamic group. In still another of these embodiments, a member of the dynamic group satisfies a requirement specified by the filter.

In one embodiment, compound conditions are stored as ‘named filters’. In another embodiment, a named filter can be edited later or reused in other filters. For example, and in still another embodiment, an administrator might specify a filter called ‘Trusted Users’ to be matched by users in a specific group, when requesting access to a resource from a client in a specific IP range, and provided that a particular virus checker is installed on the client with a specific version number. Once the filter ‘Trusted Users’ is defined, it can be used in multiple access control lists or policies, in an analogous way to group membership.

Referring now to FIG. 3A, and in greater detail, a system for dynamic generation of filters using a graphical user interface 300 includes a graphical user interface element 310, which includes a description of a first clause 315 of a filter 350. In some embodiments, the graphical user interface 300 is a filter editor. In other embodiments, the graphical user interface 300 is a Boolean expression editor. In one of these embodiments, the graphical user interface 300 is a Boolean-expression generator, creating Boolean expressions from descriptions of clauses that are not written as Boolean expressions. In still other embodiments, the graphical user interface 300 allows an administrator to define or edit a filter. In one of these embodiments, the graphical user interface 300 allows an administrator to define or edit a compound condition required of a client. In another of these embodiments, the graphical user interface 300 allows a user to describe a clause without expressing the clause as a Boolean expression. In still another of these embodiments, the graphical user interface 300 allows an administrator to define ‘leaf’ conditions, such as conditions requiring that a user be a member of a group or request access from a certain network segment. In yet another of these embodiments, the graphical user interface 300 allows an administrator to specify a combination of these conditions using ‘and,’ ‘or,’ and ‘not,’ combinations—for example: “User in group Administrator and not on an untrusted machine.” In yet other embodiments, the system receives descriptions of filters and generates filters written as Boolean expressions.

In one embodiment, the system uses data entered into the graphical user interface to generate clauses expressed in Conjunctive Normal Form (CNF). Expressions in CNF may be of the form “X and Y and Z.” where each of X, Y and Z are themselves expressions of the form “Q or W or E” and each of Q, W, and E are either leaf conditions (also referred to as “atomic terms”) or negated atomic terms. In another embodiment, the system uses data entered into the graphical user interface 300 to generate clauses composed in an extended version of CNF where Q, W, and E may also be named references to other compound expressions, or named sub-expressions that are themselves composed in the extended version of CNF, which may be referred to as Extended Conjunctive Normal Form (ECNF). In still another embodiment, the use of ECNF simplifies the task of representing expressions. For example, the expression “A or (B and C)” can be represented in CNF as “(A or B) and (A or C)” but in ECNF can also be represented as “A or D, where D is further defined as ‘B and C’”.

In some embodiments, the graphical user interface element 310 is an interface element such as a text box, a drop-down menu, or a hyperlink. In one of these embodiments, the graphical user interface element 310 displays a description of the first clause 315 of the filter 350. In another of these embodiments, the graphical user interface element 310 displays a filter name associated with the description of the disjunctive sub-clause of the first clause 315 of the filter 350. In still another of these embodiments, the text box displays a description of a first clause 315 of a filter 350, the first clause comprising a second filter. In other embodiments, a user of the graphical user interface 300 enters the description of the first clause 315 using a set of controls, including, but not limited to, text boxes, drop down lists, and graphical depictions of directories.

In some embodiments, a description of the first clause 315 includes an identification of a property of a client that satisfies the first clause 315. In other embodiments, disjunctive (or) clauses represent like items and conjunctive (and) clauses represent unlike items. For example, and in one of these embodiments, a filter for users in groups A and B indicates that a user must match either group (i.e. ‘A or B’), whereas a filter testing IP address and group membership tends to mean that both should match (i.e. ‘A and B’). In another of these embodiments, a union (or) of terms is represented as a box containing those terms. In still another of these embodiments, a conjunction (and) of terms is represented as a set of boxes. In still even another of these embodiments, the graphical user interface element 310 displays a description of a disjunctive sub-clause of the first clause of the access filter. In yet another of these embodiments, a second graphical user interface element 330 displays a description of a conjunctive clause 335 of the first clause 315 in the access filter 350. In still other embodiments, a full expression is satisfied if one term from each box is satisfied.

In some embodiments, the graphical user interface element 310 displays a filter name associated with the description of the first clause 315 of the filter 350. In one of these embodiments, the filter name is the name of a stored description of the first clause 315. In another of these embodiments, the graphical user interface element 310 displays a drop-down menu listing the filter name. In still another of these embodiments, the graphical user interface element 310 displays a list of filter names.

In other embodiments, the graphical user interface element 310 displays a name associated with a category of access control tests. In still other embodiments, atomic terms are classified as belonging to a category, the categories including, but not limited to, endpoint, network, user, server or mixed. In one of these embodiments, a term in the “endpoint” category describes a condition to be satisfied by a client device of a user requesting access to a resource. In another of these embodiments, a term in the “network” category describes a condition regarding a network from which a client device requesting access connects. In still another of these embodiments, a term in the “user” category describes a condition regarding a group in which the user is a member. In even still another of these embodiments, a term in the “server” category describes a condition to be satisfied by a server providing access to the requested resource. In yet another embodiment, a category includes terms from different categories.

The graphical user interface 300 includes one of: i) a second graphical user interface element 330 comprising a description 335 of at least one conjunctive clause of the filter 350, and ii) a description 320 in the graphical user interface element 310 of a disjunctive sub-clause of the first clause of the filter 350. In one embodiment, the graphical user interface 300 includes both the second graphical user interface element 330 and the description 320. In another embodiment, when a term is added to the filter editor, and the graphical user interface 300 already includes a box for a category associated with the term (such as graphical user interface element 310), then the term is added as a disjunctive term in the existing box. In still another embodiment, if there is no box for that category, a new box (graphical user interface element 330) is added to the graphical user interface 300.

In some embodiments, the second graphical user interface element 330 is an interface element such as a text box, a drop-down menu, or a hyperlink. In one of these embodiments, the second graphical user interface element 330 displays a description of the conjunctive clause of the filter 350. In another of these embodiments, the second graphical user interface element 330 displays a filter name associated with the description of the conjunctive clause of the filter 350. In still another of these embodiments, the second graphical user interface element 330 displays a filter name associated with a second category of access control tests. In other embodiments, the graphical user interface 300 includes one of: i) a second graphical user interface element 330 displaying a description of at least one disjunctive clause of the filter in, and ii) a description in the first graphical user interface element of a conjunctive sub-clause of the first clause of the filter.

For example, and in some of these embodiments, if a user adds two group membership tests to a filter, the terms defining each of the group membership tests will be placed in the same box (graphical user interface element 310), and if an IP range test is then also added to the graphical user interface 300, the term defining the IP range test will be placed in a separate box (graphical user interface 330).

The filter 350 is generated responsive to the contents of the first graphical user interface element 310 and the second graphical user interface element 330. In one embodiment, the filter 350 is displayed to the user in a readable format designed to avoid the inherent potential complexity of nested ‘and’ and ‘or’ operators. For example, a valid filter for ‘Trusted Users’ might be
(Client-observed IP in the range 10.70.0.0-10.70.255.255 or Client-observed IP in the range 10.30.0.0-10.30.255.255) and User in group Company\Domain Users and (Filter(Trend) or Filter(Norton))
   and this filter may be displayed in a format designed to assist the user in parsing the clauses of the filter; for example, by displaying the filter in terms of component clauses:
Network Test: Client observed IP in the range 10.70.0.0-10.70.255.255 or Client observed IP in the range 10.30.0.0-10.30.255.255
User Test User in group Company\Domain User
Endpoint Test Filter(Trend) or Filter(Norton)

In this embodiment, the representation of the filter 350 is read with an ‘AND’ between each type of test. In this embodiment, the test ‘Filter(Trend)’ is classified as an endpoint test because all atomic tests in this filter are themselves endpoint tests. In an embodiment where the ‘Trend’ filter contained a mixture of tests of different categories, it may have been given category of ‘Mixed’ and displayed as ‘Other Tests’. In some embodiments, an administrator uses the filters to generate an access control list. In other embodiments, a system, such as a policy engine, determines whether a user requesting access to a resource satisfies the conditions in the filter to determine whether or not to grant access to the requested resource. In still other embodiments, a system determines whether a user satisfies a condition expressed in a filter to determine whether the user satisfies the requirements of a policy, such as an access control policy, an auditing policy, a network routing policy, a load balancing policy, a policy relating to error reporting, or a failure handling policy.

Referring now to FIG. 3B, a screen shot depicts one embodiment of a graphical user interface in a system for dynamic generation of filters using a graphical user interface. FIG. 3B provides a screen shot of a graphical user interface 300 representing the following filter: “IPRange(10.70.0.0-10.70.255.255) AND (Group(ABC-Company\admin) OR Group(ABC-Company\users))”. The graphical user interface 300 includes a graphical user interface element 310, which includes both a filter name 360 and a description of a first clause 315 of the filter 350. The graphical user interface 300 also includes a graphical user interface element 330, which includes a filter name 370, a description of a second clause 335 of the filter 350, and a description of a disjunctive sub-clause 340 of the filter 350.

Referring now to FIG. 3C, a screen shot depicts another embodiment of a graphical user interface 300. In this embodiment, the graphical user interface 300 explicitly specifies the logical relationship between the sub-clauses and clauses of the filter. Additionally, the graphical user interface 300 depicts a graphical user interface element shaded to indicate that graphical user interface element does not yet contain a description of a clause or sub-clause of the filter and is, instead, an inactive placeholder for an additional expression.

Referring now to FIG. 3D, a screen shot depicts another embodiment of a system for dynamic generation of filters using a graphical user interface. In some embodiments, the graphical user interface 300 receives a term from a user and applies a heuristic to automatically add the term to the appropriate graphical user interface element 310 or 330. In one of these embodiments, and as depicted in FIG. 3D, the graphical user interface 300 may include a user interface element 375 to allow a user to move a term from one graphical user interface element to another. In FIG. 3D, graphical user interface element 375 is a pull-down menu that allows a user to move a term from graphical user interface 370 to graphical user interface 310 (“Move to Network Tests”), or to a new user interface element (“Move to an empty box”), or to remove the element, or to edit or negate the term.

FIG. 3D includes a graphical user interface element 380, labeled “Add Condition.” In one embodiment, the graphical user interface element 380 is used to add new atomic tests to the filter. In another embodiment, the graphical user interface element 380 allows the addition of new filters (compound expressions) that are named and represented in the tool as if they were atomic tests. For example, if the user had previously defined a named filter (such as, “Client Machine has Trend installed”), then this filter could be added as an atomic test within the filter 350 generated by the graphical user interface 300.

Referring now to FIG. 3E, a screen shot depicts one embodiment of a graphical user interface for adding a condition to a filter. In one embodiment, selection of the graphical user interface element 380 depicted in FIG. 3D results in the display of graphical user interface 390 depicted in FIG. 3E. In another embodiment, the graphical user interface 390 is a menu listing at least one type of atomic test available for use in a filter 350, including, but not limited to sub-expressions, references to existing filters, property comparisons, IP Range tests, Group Membership tests, and time-of-day testing. In still another embodiment, when a test is selected, a dialog box is provided to allow the administrator to fill in (or edit) details related to that test. In still even another embodiment, if the user selects a ‘property comparison’ test, a dialog box is provided to allow the user to select which property of the client device is to be compared, and to which value the property should be compared. Client device-related properties may include User Id, IP Address, Call Time and endpoint information, such as the presence/absence of client features and/or the version number of client-installed software. In yet another embodiment, a number of comparison operators are supported, such as equality, greater than, less than, uncased comparison (for strings) and ‘is-a’ for enumerations.

Referring now to FIG. 3F, a screen shot depicts an embodiment of a graphical user interface for displaying a first filter included as a term in a second filter. The graphical user interface 392 depicts a first sub-clause 394 and a second sub-clause 396, each of which are named filters nested within the first clause of the filter described by graphical user interface 392. Sub-clause 396 is described in a graphical user interface element similar to those described above. Sub-clause 394 explicitly lists the clauses of the named filter “Trend 98”, displaying to the user the clauses specified by the nested filter.

Referring now to FIG. 3G, a screen shot depicts one embodiment of a graphical user interface for customizing a clause of a filter. As depicted in FIG. 3G, properties provided by the graphical user interface 300 are extensible and customizable. For example, and in one embodiment, an administrator might select an operating system from a plurality of pre-defined operating systems, for example by identifying a client operating system as a parameter to customize, selecting a type of comparison (“is”) to associate with the parameter, and selecting a particular operating system from an enumeration of values (such as the different versions of the WINDOWS operating system listed in FIG. 3G). In one embodiment, an ‘is-a’ comparison with the value “WINDOWS” would satisfy the condition if the client operating system had a name including the value “WINDOWS.”

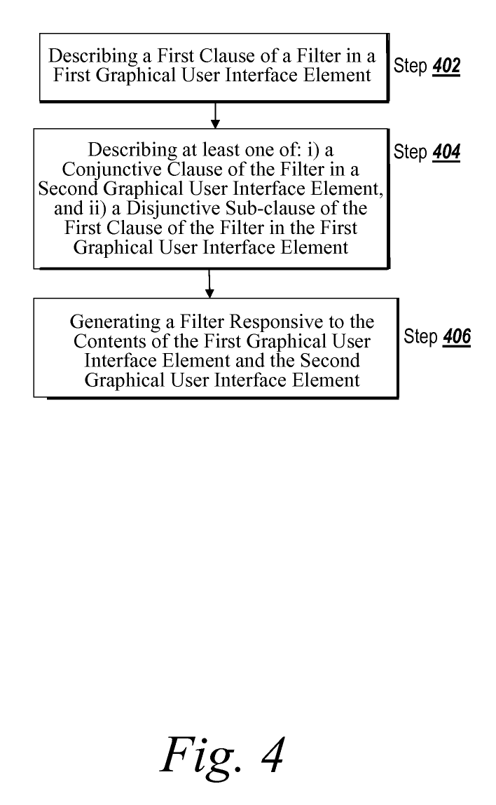

Referring now to FIG. 4, a flow diagram depicts one embodiment of the steps taken in a method for dynamic generation of filters using a graphical user interface. In brief overview, a first clause of a filter is described in a first graphical user interface element (step 402). At least one of a conjunctive clause of the filter, in a second graphical user interface element, and a disjunctive sub-clause of the first clause of a filter, in the first graphical user interface element, are described (step 404). A filter is generated responsive to the contents of the first graphical user interface element and the second graphical user interface element (step 406).

Referring now to FIG. 4, in greater detail and in connection with FIG. 3A, a first clause of a filter is described in a first graphical user interface element (step 402). In one embodiment, a first clause of the filter is described, the first clause comprising a second filter. In another embodiment, a description of the first clause is received from a user via a third graphical user interface element. In still another embodiment, the first clause of the filter is described using a non-algebraic language.

At least one of a conjunctive clause of the filter, in a second graphical user interface element, and a disjunctive sub-clause of the first clause of a filter, in the first graphical user interface element, are described (step 404). In one embodiment, a description is provided of at least one of: i) a disjunctive clause of the filter in a second graphical user interface element, and ii) a conjunctive sub-clause of the first clause of the filter in the first graphical user interface element. In another embodiment, a description is provided of a conjunctive clause of the filter using a non-algebraic language. In still another embodiment, a description is provided of a disjunctive sub-clause of the first clause of the filter using a non-algebraic language. In yet another embodiment, a description is provided of a disjunctive sub-clause of the one or more disjunctive sub-clauses.

In one embodiment, a description is provided of a conjunctive sub-clause of the disjunctive sub-clause. In another embodiment, a description is provided of a disjunctive sub-clause of the conjunctive clause. In still another embodiment, a description is provided of a conjunctive clause of the filter.

In one embodiment, a graphical user interface element is generated for each conjunctive clause in the plurality of conjunctive clauses, the generated graphical user interface element displaying a description of the conjunctive clause. In another embodiment, a description is provided of a second filter as a disjunctive sub-clause of the first clause of the filter. In still another embodiment, a description is provided of a second filter as a disjunctive sub-clause of the conjunctive clause of the filter.

A filter is generated responsive to the contents of the first graphical user interface element and the second graphical user interface element (step 406). In some embodiments, only a first clause is provided and the filter is generated using the first clause. In one embodiment, the filter is described using a non-algebraic language. In some embodiments, the filter is stored. In one of these embodiments, the filter is stored in memory. In another of these embodiments, the filter is stored in a database. In still another of these embodiments, the filter is stored on a server 106. In other embodiments, a policy engine, such as the policy engine described above in connection with FIG. 2A and FIG. 2B, stores the filter. In one of these embodiments, the policy engine resides on a server 106.

In one embodiment, a clause in the filter is modified by using at least a third graphical user interface element to modify a description of the modified clause. In another embodiment, the modification to the clause in the filter includes converting a conjunctive clause of the clause to a disjunctive clause. In still another embodiment, the modification to the clause in the filter includes an addition of a description of the modified clause into the first graphical user interface element and deleting the description of the modified clause from the second graphical user interface element. In still another embodiment, the modification to the clause in the filter includes converting a disjunctive clause of the first clause to a conjunctive clause. In yet another embodiment, the modification to the clause in the filter includes generating a new graphical user interface element, adding the description of the modified clause into the generated graphical user interface element and deleting the description of the modified clause from the first graphical user interface element.

In some embodiments, an access control list is generated using the filter 350. In one of these embodiments, an administrator specifies the access control list. In another of these embodiments, a policy engine generates the access control list. In other embodiments, a policy engine uses a filter in determining whether or not to allow a user of a client device to access a resource. In still other embodiments, a policy engine uses a filter in selecting a method for execution of a resource when allowing a user of a client device to access a resource.

In some embodiments, a server 106 receives a request for access to a resource, such as execution of an application program, from a client device. In one of these embodiments, the requested resource is a file. In another of these embodiments, the requested resource is an application program. In still another of these embodiments, the requested resource is a computing environment. In still even another of these embodiments, the computing environment is a desktop environment from which the client device may execute application programs. In yet another of these embodiments, the computing environment provides access to one or more application programs.

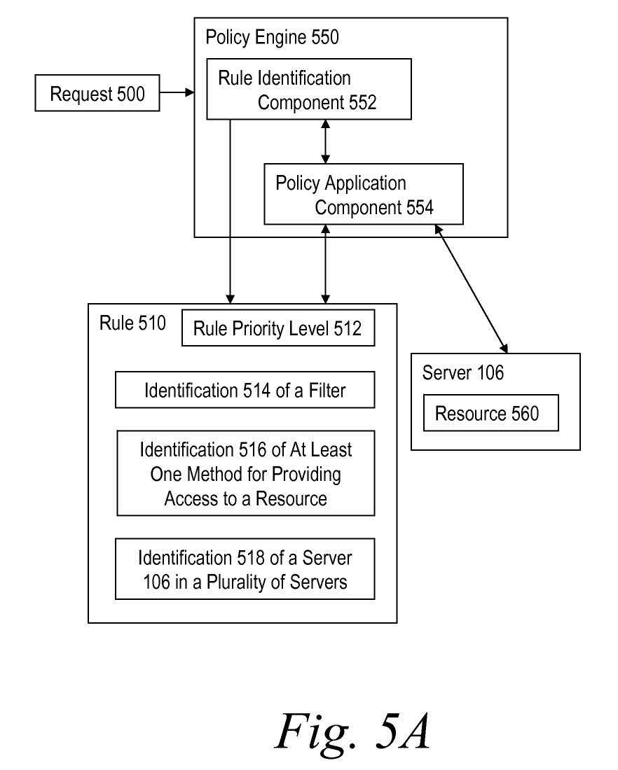

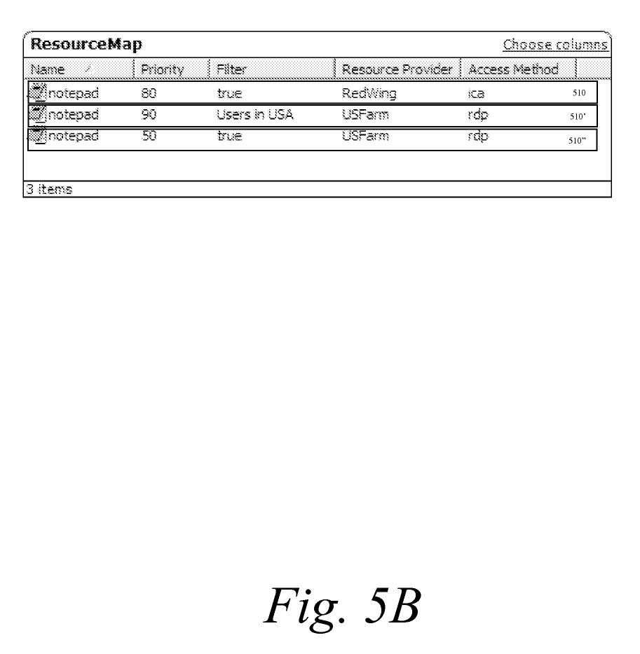

Referring now to FIG. 5A, a system for access routing and resource mapping using filters includes a rule 510, a policy engine 550, and a server 106. In brief overview, the rule 510 has a first rule priority level 512 and includes i) an identification 514 of a filter identifying at least one pre-requisite to accessing a resource 560, ii) an identification 516 of at least one method for providing access to a resource, and iii) an identification 518 of a server 106 in a plurality of servers. The policy engine 550 includes a rule identification component 552 and a policy application component 554. The rule identification component 552 includes means for identifying the rule 510. The policy application component 554 includes means for applying the filter to a client request for access to the resource, means for determining that the client satisfies the at least one pre-requisite, responsive to applying the filter, and means for determining whether to provide access to the resource to the client by the server in the plurality of servers according to the at least one method for providing access to the resource. The server 106 in the plurality of servers provides access to the resource 460 according to the at least one method for providing access.

In one embodiment, a filter 350 is generated as described above in connection with FIGS. 3-4. In another embodiment, the filter 350 is stored and applied to decisions regarding whether or not to grant access to a requested resource. In some embodiments, the filter 350 is used to define a resource mapping policy, which specifies whether and how a user of a client device may access a resource, and which server will provide access to the resource. In one of these embodiments, resources in a list of published resources represent all resources available to a user of a client, from the client's perspective. For example, the list of published resources may contain a single ‘Notepad’ resource, although there may be a number of mechanisms available to provide the resource to the client-several copies of Notepad may reside on different resource providers, or one or more resource provider may be able to provide access to the resource using different mechanisms, including but not limited to downloading the resource to the client, executing the resource remotely and transmitting application-output data to the client. A resource mapping policy specifies which resource to use, from which resource provider, and via which execution method.

Referring now to FIG. 5A, and in greater detail, the rule 510 has a first rule priority level 512 and includes i) an identification 514 of a filter identifying at least one pre-requisite to accessing a resource 560, ii) an identification 516 of at least one method for providing access to a resource, and iii) an identification 518 of a server 106 in a plurality of servers. In one embodiment, a plurality of rules forms a resource mapping policy. In another embodiment, the first rule priority level 512 is a numeric priority level. In still another embodiment, a policy engine 550 consults a rule to determine whether to grant access to a requested resource. In yet another embodiment, the policy engine 550 selects a rule to consult based on the first rule priority level 512.

In some embodiments, the identification 514 identifies a stored filter. In other embodiments, the identification 514 specifies a condition to be satisfied by a client requesting access to a resource. In one of these embodiments, the identified filter identifies a pre-requisite specifying a network address range required for access to the resource. In another of these embodiments, the identified filter identifies a pre-requisite specifying an operating system type required for access to the resource. In still another of these embodiments, the identified filter identifies a pre-requisite specifying an application type required for access to the resource. In yet another of these embodiments, the identified filter identifies a pre-requisite specifying a characteristic of the client device requesting access to the resource, such as an application to be installed on the client device or a hardware resource available to the client device. In still other embodiments, the identified filter specifies a condition. In one of these embodiments, if the condition is true for the client device, the client satisfies the identified filter. In another of these embodiments, if the condition is false for the client device, the client satisfies the identified filter.

In one embodiment, the identification 516 identifies a method for providing access to the resource 560 by streaming the resource to the client. In another embodiment, the identification 516 identifies a method for providing access to the resource 560 by executing the resource on a server 106 in a plurality of servers, such as a server in a server farm, and transmitting application-output data to the client using a presentation layer protocol. In still another embodiment, the identification 516 identifies a method for providing access to the resource 560 by executing the resource on a virtual machine executing on a server in the plurality of servers and transmitting application-output data to the client using a presentation layer protocol. In yet another embodiment, the identification 516 identifies a method for providing access to the resource 560 by transmitting the resource to the client requesting access.

In one embodiment, the identification 518 identifies a server 106 that provides access to the resource 560 by transmitting the resource 560 to the requesting client. In another embodiment, the identification 518 identifies a server 106 that provides access to the resource 560 by executing the resource 560 and transmitting application-output data to the client using a presentation layer protocol. In still another embodiment, the identification 518 specifies a plurality of servers, one of which may be selected to provide access to the requested resource.

In one embodiment, the rule 510 indicates that a specific resource provider and specific mechanism should be used to service a request. In another embodiment, the resource provider is a server 106. In another embodiment, the mechanism for servicing the request identifies a method for downloading a first portion of the requested resource to the client device, executing the first portion of the requested resource, and downloading a second portion of the requested resource to the client device, referred to, in some embodiments, as streaming the resource to the client device. In still another embodiment, the mechanism for servicing the request identifies a method for downloading the requested resource to the client device. In still even another embodiment, the mechanism for servicing the request identifies a method for executing the requested resource on a server and transmitting application-output data to the client device. In yet another embodiment, and for example, a rule 510 specifies:

Priority 90

Filter ‘Remote User’

Provide access to all resources using ICA and the ‘EMEA’ farm.

In this embodiment, the first rule priority level is 90, the identification 514 identifies a named filter stored as “remote user,” and the identification 516 specifies that for this user, access should be provided to all resources by executing the requested resource on a machine in the “EMEA” farm and the application-output data generated by the executing resource should be transmitted to the client device using a presentation layer protocol such as the Independent Computing Architecture (ICA) protocol.

In one embodiment, when a request is received for access a resource, resource mapping policy rules are consulted in order from highest priority through lowest. In another embodiment, a policy engine 550 includes means for identifying a second rule having a lower rule priority level than the first rule priority level 512, the second rule associated with a second method for providing access to the resource 560 and a second server 106b in the plurality of servers. In still another embodiment, if a user or the user's client device does not satisfy the requirements of the specified filter, the policy engine 550 identifies the second rule. In still even another embodiment, if the requested resource is not provided on the specified resource provider, using the specified mechanism, the policy engine 550 identifies the second rule. In yet another embodiment, if the client device is unable to support the use of the specified mechanism, or the resource provider is overloaded or has failed, the policy engine 550 identifies the second rule.

In one embodiment, a policy engine 550 determines that a user and the user's client device satisfy the requirements of the identified filter specified in the rule 510. In another embodiment, the policy engine 550 selects the resource provider and the mechanism identified in the rule 510 to provide the user with access to the resource. In still another embodiment, the policy engine 550 stops processing rules once a rule is identified that the client satisfies. In yet another embodiment, if there is a failure during execution of the requested resources, the policy engine identifies a second rule and begins processing rules to identify a rule satisfied by the client.

In one embodiment, the policy engine 550 includes means for determining whether to provide access to the resource 560 to the client by the second server 106b in the plurality of servers according to the second method for providing access to the resource 560. In another embodiment, the second server 106b in the plurality of servers provides access to the resource 560 according to the second method for providing access. In still another embodiment, the second server 106b in the plurality of servers provides access to the resource 560 according to the first method for providing access.

In one embodiment, the policy engine 550 includes means for identifying a second rule having a lower rule priority level than the first rule priority level, the second rule associated with a second filter, a second method for providing access to the resource, and a second server in the plurality of servers. In another embodiment, the policy engine 550 includes means for determining that the client satisfies at least one pre-requisite associated with the second filter, responsive an application of the second filter. In still another embodiment, the policy engine 550 includes means for determining whether to provide access to the resource to the client by the second server in the plurality of servers according to the second method for providing access to the resource. In yet another embodiment, the second server in the plurality of servers provides access to the resource according to the second method for providing access.

Referring now to FIG. 5B, a screen shot depicts one embodiment of a subset of rules in a resource mapping policy. FIG. 5B depicts three rules 510, 510′, and 510″. Rule 510 has a priority level of 80, identifies a named filter “true”, identifies a resource provider “RedWing” and an access method that specifies the use of the ICA presentation layer protocol. Rule 510′ has a priority level of 90, identifies a named filter “Users in USA”, identifies a plurality of resource providers (servers in the “USFarm” server farm) and an access method that specifies the use of the RDP presentation layer protocol. Rule 510″ has a priority level of 50, identifies a named filter “true”, identifies a plurality of resource providers (servers in the “USFarm” server farm) and an access method that specifies the use of the RDP presentation layer protocol. In this embodiment, the filter “true” identifies a filter trivially matched by all clients.

In one embodiment, the policy engine 550 determines that the user requesting access to the requested resource (notepad) satisfies the requirements of the “Users in USA” filter in the rule 510′, which has the highest priority level, and the policy engine 550 identifies a server in the “USFarm” server farm able to provide access to the notepad resource using the RDP presentation layer protocol. In another embodiment, the policy engine 550 determines that the user, or the user's client device, does not satisfy the requirements of the filter, or that the resource providers (servers in the server farm “USFarm”) are unable to provide access to the notebook resource using the RDP presentation layer protocol. In still another embodiment, the policy engine 550 determines that the user and the user's client device satisfy the requirements of the filter named “true” and the policy engine identifies a server “RedWing” to provide access to the notebook resource using the ICA presentation layer protocol. In still even another embodiment, the policy engine 550 determines that the resource provider (the “RedWing” server) is unable to provide access to the notebook resource using the ICA presentation layer protocol. In yet another embodiment, the policy engine 550 determines that the user and the user's client device satisfy the requirements of the filter named “True” and the policy engine 550 identifies a server in the “USFarm” server farm to provide access to the notebook resource using the RDP presentation layer protocol.

In one embodiment, a subset of rules which may apply to a user or the user's client device is displayed to an administrator. In another embodiment, a subset of rules in a resource mapping policy which identify a particular resource provider is displayed. In still another embodiment, a subset of rules in a resource mapping policy which identify a particular mechanism for providing access to the resource is displayed.

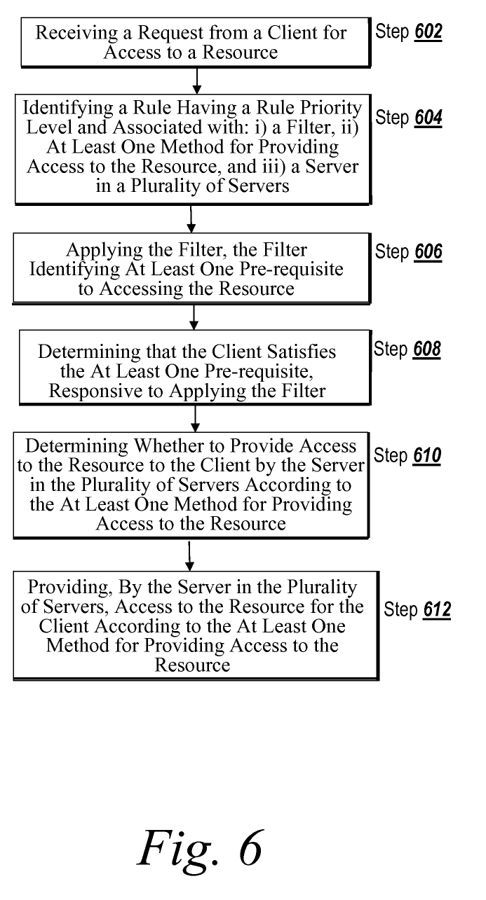

Referring now to FIG. 6, a method for access routing and resource mapping using filters includes the step of receiving a request from a client for access to a resource (step 602). A rule is identified, the rule having a rule priority level and associated with: i) a filter, ii) at least one method for providing access to the resource, and iii) a server in a plurality of servers (step 604). The filter is applied, the filter identifying at least one pre-requisite to accessing the resource (step 606). A determination is made that the client satisfies the at least one pre-requisite, responsive to applying the filter (step 608). A determination is made regarding whether to provide access to the resource to the client by the server in the plurality of servers according to the at least one method for providing access to the resource (step 610). The server in the plurality of servers provides access to the resource for the client according to the at least one method for providing access to the resource (step 612).

Referring now to FIG. 6, and in greater detail, a request is received from a client for access to a resource (step 602). In one embodiment, a client 102 transmits the request 500 to a server 106a, requesting access to a resource 560 provided by a server 106b. In another embodiment, the policy engine 550 receives the request. In still another embodiment, a server 106a forwards the request to the policy engine 550.

A rule is identified, the rule having a rule priority level and associated with: i) a filter, ii) at least one method for providing access to the resource, and iii) a server in a plurality of servers (step 604). In one embodiment, the rule 510 is associated with a method for providing access to the resource by streaming the resource to the client. In another embodiment, the rule 510 is associated with a method for providing access to the resource by transmitting application-output data to the client using a presentation layer protocol. In still another embodiment, the rule 510 is associated with a method for providing access to the resource by executing the resource on a virtual machine executing on the server in the plurality of servers and transmitting application-output data to the client from the virtual machine using a presentation layer protocol. In yet another embodiment, the rule 510 is associated with a method for transmitting the resource to the client.

The filter is applied, the filter identifying at least one pre-requisite to accessing the resource (step 606). In one embodiment, the filter is applied to the client. In another embodiment, the filter is applied to a user of the client. In still another embodiment, the filter is applied to information associated with the client or with the user of the client device. In yet another embodiment, the policy engine 550 applies the filter to determine whether and how to grant access to the requested resource.

A determination is made that the client satisfies the at least one pre-requisite, responsive to applying the filter (step 608). In some embodiments, the policy engine 550 determines that the client satisfies the at least one prerequisite. In one of these embodiments, the policy engine 550 determines that the client executes a specified anti-virus program. In another of these embodiments, the policy engine 550 determines that the client is associated with a network address in a specified range of network addresses. In still another of these embodiments, the policy engine 550 determines that the client executes a specified operating system program.

A determination is made regarding whether to provide access to the resource to the client by the server in the plurality of servers according to the at least one method for providing access to the resource (step 610). In one embodiment, the policy engine 550 determines that the user and the user's client device satisfy the requirements specified by the identified filter. In another embodiment, the policy engine 550 identifies the server 106 and the at least one method for providing access to the resource and grants the user access to the resource via the at least one method for providing, by the server 106, the resource.

The server in the plurality of servers provides access to the resource for the client according to the at least one method for providing access to the resource (step 612). In one embodiment, the server 105 is a resource provider selected to provide access to the resource for the client. In another embodiment, the policy engine 550 selects the server 106 responsive to applying a filter to the client and the server. In still another embodiment, the policy engine 550 selects the server to provide the access according to a rule having a priority level.

In some embodiments, a first rule is identified and a determination is made as to whether the client satisfies the associated policy and as to whether the identified server is able to provide the client with access to the requested resource according to the specified method. In one of these embodiments, if the client does not satisfy the policy, a different rule is identified, the second rule associated with a second policy and specifying the same server and the same method. In another of these embodiments, if the client does not satisfy the policy, a different rule is identified, the second rule associated with a second policy and specifying a different server or method. In still another of these embodiments, if the client satisfies the policy, but is unable to access the resource according to the specified method, a different rule is identified, the second rule associated with a different method and the same policy and the same server. In yet another of these embodiments, if the client satisfies the policy, but is unable to access the resource according to the specified method, a different rule is identified, the second rule associated with a different method and a different policy or server.

In one embodiment, an identification is made of a second rule having a lower rule priority level than the first rule priority level, the second rule associated with a second method for providing access to the resource and associated with a second server in the plurality of servers. In some embodiments, a determination is made that the client fails to satisfy the at least one pre-requisite, responsive to applying the filter to information associated with at least one of the client and the user of the client. In other embodiments, a determination is made that the client is unable to use the at least one method for providing access specified by the rule. In one of these embodiments, the client satisfies the policy associated with the resource but lacks a requirement necessary for using the method specified by the rule. In still other embodiments, a determination is made that the server in the plurality of servers by the rule is unable to provide the resource to the client via the at least one method for providing access. In one of these embodiments, the server lacks the resource. In another of these embodiments, the server is overloaded or unavailable. In still another of these embodiments, the server lacks the ability to provide access via the specified method.

In one embodiment, an identification is made of a second rule having a lower rule priority level than the first rule priority level, the second rule associated with a second server in the plurality of servers and with the at least one method specified by the first rule having the first rule priority level. In another embodiment, an identification is made of a second rule having a lower rule priority level than the first rule priority level, the second rule associated with a second method for providing access to the resource and associated with the first server in the plurality of servers.

In some embodiments, a determination is made as to whether to access to the resource to the client by the second server in the plurality of servers according to the second method for providing access to the resource. In one of these embodiments, the second server in the plurality of servers provides access to the resource according to the second method for providing access. In another of these embodiments, a second filter is applied. In other embodiments, a determination is made as to whether to provide access to the resource to the client by the second server in the plurality of servers according to the at least one method for providing access to the resource. In one of these embodiments, the at least one method is the method specified by the first rule having the first rule priority level. In another of these embodiments, the second server in the plurality of servers provides access to the resource according to the at least one method for providing access.

In some embodiments, an identification is made of a second rule having a lower rule priority level than the first rule priority level, the second rule associated with a second filter, a second method for providing access to the resource, and a second server in the plurality of servers. In one of these embodiments, a determination is made that the client fails to satisfy the at least one pre-requisite, responsive to applying the filter. In another of these embodiments, a determination is made that the client is unable to use the method for providing access specified by the rule. In still another of these embodiments, a determination is made that the server in the plurality of servers by the rule is unable to provide the resource to the client via the first method for providing access.

In other embodiments, an identification is made of a second rule having a lower rule priority level than the first rule priority level, the second rule associated with a second filter, the at least one method for providing access to the resource and a second server in the plurality of servers.

In still other embodiments, an identification is made of a second rule having a lower rule priority level than the first rule priority level, the second rule associated with a second filter, a second method for providing access to the resource and the server in the plurality of servers. In one of these embodiments, a determination is made that the client satisfies at least one pre-requisite associated with the second filter, responsive to an application of the second filter. In another of these embodiments, a determination is made as to whether to access to the resource to the client by the second server in the plurality of servers according to the second method for providing access to the resource. In still another of these embodiments, a determination is made that the client is able to use the second method for providing access specified by the second rule. In still even another of these embodiments, a determination is made that the second server in the plurality of servers by the rule is able to provide the resource to the client via the at least one method for providing access. In yet another of these embodiments, the second server in the plurality of servers provides access to the resource according to the second method for providing access.

In one embodiment, a determination is made as to whether to provide access to the resource to the client by the server in the plurality of servers according to a second method for providing access to the resource. In another embodiment, a determination is made as to whether the client satisfies a policy associated with a rule identifying the server and the second method. In still another embodiment, a determination is made as to whether to provide access to the resource to the client by a second server in the plurality of servers according to the at least one method for providing access to the resource. In still even another embodiment, a determination is made as to whether the client satisfies a policy associated with a rule identifying the second server and the first method. In yet another embodiment, a determination is made as to whether to provide access to the resource to the client by a second server in the plurality of servers according to a second method for providing access to the resource.

In some embodiments, the policy engine 550 identifies a rule applicable to a client request for access to a resource. In another embodiment, the policy engine 550 determines whether the client satisfies a policy associated with the rule. In still another embodiment, the policy engine 550 determines whether the client is able to access the resource according to the specified method for accessing the resource. In yet another embodiment, the policy engine 550 determines whether the identified resource provider is able to provide the requested resource according to the specified method for providing access. In other embodiments, the policy engine 550 continues to identify rules and apply the associated rules to the client until a rule is found that is associated with a policy the client satisfies and that identifies a server capable of providing the client with access to the requested rule according to a specified method.

The systems and methods described above may be provided as one or more computer-readable programs embodied on or in one or more articles of manufacture. The article of manufacture may be a floppy disk, a hard disk, a CD-ROM, a flash memory card, a PROM, a RAM, a ROM, or a magnetic tape. In general, the computer-readable programs may be implemented in any programming language, LISP, PERL, C, C++, PROLOG, or any byte code language such as JAVA. The software programs may be stores on or in one more articles of manufacture as object code.

Having described certain embodiments of methods and systems for dynamic generation of filters using a graphical user interface, it will now become apparent to one of skill in the art that other embodiments incorporating the concepts of the invention may be used. Therefore, the invention should not be limited to certain embodiments, but rather should be limited only by the spirit and the scope of the following claims.

What is claimed is:

1. A method for dynamic generation of filters using a graphical user interface, the method comprising the steps of:
(a) describing a first clause of a filter in a first graphical user interface element;
(b) describing at least one of: i) a conjunctive clause of the filter in a second graphical user interface element, and ii) a disjunctive sub-clause of the first clause of the filter in the first graphical user interface element; and
(c) generating a filter responsive to the contents of the first graphical user interface element and the second graphical user interface element.

2. The method of claim 1, wherein step (a) further comprises describing the first clause of the filter, the first clause comprising a second filter.

3. The method of claim 1, wherein step (a) further comprises receiving the description of the first clause from a user via a third graphical user interface element.

4. The method of claim 1, wherein step (a) further comprises describing the first clause of the filter using a non-algebraic language.

5. The method of claim 1, wherein step (b) comprises describing at least one of: i) a disjunctive clause of the filter in a second graphical user interface element, and ii) a conjunctive sub-clause of the first clause of the filter in the first graphical user interface element.

6. The method of claim 1, wherein step (b) further comprises describing a conjunctive clause of the filter using a non-algebraic language.

7. The method of claim 1, wherein step (b) further comprises describing a disjunctive sub-clause of the first clause of the filter using a non-algebraic language.

8. The method of claim 1, wherein step (b) further comprises describing a disjunctive sub-clause of the one or more disjunctive sub-clauses.

9. The method of claim 1, wherein step (b) further comprises describing a conjunctive sub-clause of the disjunctive sub-clause.

10. The method of claim 1, wherein step (b) further comprises describing a disjunctive sub-clause of the conjunctive clause.

11. The method of claim 1, wherein step (b) further comprises describing a plurality of conjunctive clauses of the filter.

12. The method of claim 11, further comprising the step of generating a graphical user interface element for each conjunctive clause in the plurality of conjunctive clauses, the generated graphical user interface element comprising a description of the conjunctive clause.

13. The method of claim 1, wherein step (b) further comprises describing a second filter as a disjunctive sub-clause of the first clause of the filter.

14. The method of claim 1, wherein step (b) further comprises describing a second filter as a disjunctive sub-clause of the conjunctive clause of the filter.

15. The method of claim 1, wherein step (c) further comprises describing the filter using a non-algebraic language.

16. The method of claim 1 further comprising the step of modifying a clause in the filter by using at least a third graphical user interface element to modify a description of the modified clause.

17. The method of claim 16, wherein the step of modifying a clause further comprises converting a conjunctive clause of the clause to a disjunctive clause.

18. The method of claim 17, wherein the step of modifying a clause further comprises adding the description of the modified clause into the first graphical user interface element and deleting the description of the modified clause from the second graphical user interface element.

19. The method of claim 16, wherein the step of modifying a clause further comprises converting a disjunctive clause of the first clause to a conjunctive clause.

20. The method of claim 19, wherein the step of modifying a clause further comprises the steps of:
i. generating a new graphical user interface element,
ii. adding the description of the modified clause into the generated graphical user interface element, and
iii. deleting the description of the modified clause from the first graphical user interface element.

21. A system for dynamic generation of filters using a graphical user interface, the system comprising:
a graphical user interface element comprising a description of a first clause of a filter;
one of: i) a second graphical user interface element comprising a description of at least one conjunctive clause of the filter, and ii) a description in the first graphical user interface element of a disjunctive sub-clause of the first clause of the filter; and
a filter generated responsive to the contents of the first graphical user interface element and the second graphical user interface element.

22. The system of claim 21, wherein the first graphical user interface element further comprises a text box displaying the description of the first clause of the filter.

23. The system of claim 21, wherein the first graphical user interface element further comprises a description of a first clause of a filter, the first clause comprising a second filter.

24. The system of claim 21, wherein the first graphical user interface element further comprises a text box displaying a filter name associated with the description of the first clause of the filter.

25. The system of claim 21, wherein the first graphical user interface element further comprises a text box displaying a name associated with a first category of access control tests.

26. The system of claim 21, wherein the first graphical user interface element further comprises a text box displaying a description of a disjunctive sub-clause of the first clause of the filter.

27. The system of claim 21, wherein the first graphical user interface element further comprises a text box displaying a filter name associated with the description of the disjunctive sub-clause of the first clause of the filter.

28. The system of claim 21, wherein the second graphical user interface element further comprises a text box displaying the description of the conjunctive clause of the filter.

29. The system of claim 21, wherein the second graphical user interface element further comprises a text box displaying a filter name associated with the description of the conjunctive clause of the filter.

30. The system of claim 21, wherein the second graphical user interface element further comprises a text box displaying a filter name associated with a second category of access control tests.

31. The system of claim 21, wherein the system further comprises one of: i) a second graphical user interface element comprising a description of at least one disjunctive clause of the filter in, and ii) a description in the first graphical user interface element of a conjunctive sub-clause of the first clause of the filter.
